(19) United States
(12) Patent Application Publication
(10) Pub. No.: US 2015/0269670 A1
(43) Pub. Date: Sep. 24, 2015

(54) METHOD, SYSTEM, AND APPARATUS FOR SEMI-AUTOMATIC RISK AND AUTOMATIC TARGETING AND ACTION PRIORITIZATION IN LOAN MONITORING APPLICATIONS

(71) Applicant: Xerox Corporation, Norwalk, CT (US)

(72) Inventors: Alvaro E. Gil, Rochester, NY (US); Edgar A. Bernal, Webster, NY (US); Shanmuga-Nathan Gnanasambandam, Victor, NY (US)

(73) Assignee: Xerox Corporation, Norwalk, CT (US)

(21) Appl. No.: 14/222,099

(22) Filed: Mar. 21, 2014

(51) Int. Cl. G06Q 40/02

(52) U.S. Cl. CPC G06Q 40/025

(57) ABSTRACT

Presented are a method, system, and apparatus for semi-automatic and automatic loan risk targeting and action prioritization in loan monitoring applications. In an off-line mode, a computing device associated with a multi-window computer-based tool receives a plurality of loan account histories for loan risk analysis. A predictive multi-output risk model is trained with the received plurality of loan account histories, the predictive multi-output risk model indicating a risk level associated with each of the loan accounts. In an online mode, the user is presented an option for semi-automatic loan analysis, in which the user is presented with output of a predictive multi-output risk model associated with the plurality of loan accounts. The user is also presented with the option for automatic loan analysis, allowing the user to be automatically presented with loan accounts at a greatest level of risk of all loan accounts.

This application is related to co-filed U.S. patent application Ser. No. 14/221,723 and U.S. patent application Ser. No. 14/221,944. These patent applications are incorporated in their entirety here.

### TECHNICAL FIELD

The present invention is related to the field of loan risk assessment and computer-based loan risk tools. The invention is directed towards a method, system, and apparatus for semi-automatic and automatic loan risk analysis and automatic loan analysis capabilities in loan monitoring applications. In an off-line mode associated with a computing device, a plurality of loan account histories are utilized to train a predictive multi-output risk model. In an online mode, the multi-window computer-based tool presents options for both automatic loan analysis and semi-automatic loan analysis via a graphic user interface, or multiple graphic user interfaces, allowing a user or users to monitor a plurality of loan accounts for risk of default.

### BACKGROUND

The personal lending industry, including the lending of student loans, auto loans, commercial loans, and mortgages, as well as other types of personal loans is valued at trillions of dollars in the United States in the twenty-first century. The total value of mortgages outstanding alone in the United States is $10 trillion dollars. The total value of all student loans outstanding in the United States in 2013 is currently between $902 billion and $1 trillion. The sheer volume of this debt leads to a large amount of competition among lenders, trying to extend the greatest number of loans which have a reasonable chance of being repaid with interest. The tendency to over-purchase existing personal loan accounts from other lenders as well as over-lend leads to situations such as presented in the 2009 Financial Crisis in which defaults of large amounts of mortgages and mortgage-backed securities consisting of individual homeowners' mortgages led to the failure of the entire banking industry, and the need for government bailouts to prevent another Great Depression.

Personal loan accounts consist of accounts such as auto loans, home mortgages, personal lines of credit, credit cards, student loans, and similar types of lending arrangements made to individuals. Whether a lender or loan servicer obtains management of personal loan accounts through direct lending, via assignment of an existing personal loan account, or any other means, the need to obtain information on loan risks remains. In any event once management of a personal loan account has been obtained it is necessary to continuously monitor the potential for default for the personal loan account itself. Collection services as well require information on the status of loans, and whether collection should be pursued or not. Monitoring is required to determine whether the personal loan remains an asset valuable enough to remain “on the books,” whether to file a lawsuit against the personal loan holder to collect on the debt, sell the personal loan to another owner loan servicer, or any other recourse.

With the specific example of the loan service provider industry, the number of loan accounts managed by a loan account service provider may number in the millions, even if only 6-10% of a population of loan accounts may be at risk of default at any one time, this may still amount to hundreds of thousands of loan accounts at risk of default at any one time, all requiring close surveillance. Accordingly, a need exists for a system, method, and apparatus for loan risk targeting and action prioritization which facilitates semi-automatic and automatic loan analysis capabilities and determination of future risk.

### SUMMARY

The present invention is directed towards a method, system, and apparatus for loan risk targeting and action prioritization using a multi-window computer-based tool associated with a computing device offering semi-automatic and automatic loan analysis capabilities for a user or multiple users.

In an embodiment of the invention, the invention comprises an off-line mode associated with the computing device. Some or all of a number of steps are performed during the off-line mode as is discussed herein. A definition is received from a single user of a predetermined maximum look-ahead timeframe p. A computing device associated with the multi-window computer-based tool then receives a plurality of loan account histories describing a plurality of loan accounts transmitted from a first computer database for loan risk analysis. A predictive multi-output risk model is trained with the plurality of loan account histories. The predictive multi-output risk model indicates a loan risk level associated with each of the received plurality of loan account histories and loan accounts according to a periodic basis up to the predetermined maximum look-ahead timeframe p. The “periodic basis” is discussed more extensively herein but the periodic basis may be a daily, weekly, bi-weekly, monthly, bi-monthly, or annual basis. The periodic basis may be selected by a single user during the off-line mode, such as via a periodic basis selection window in the multi-window computer-based tool. The predictive multi-output risk model is then stored in a second computer database.

The invention further comprises in some embodiments an “online mode.” The online mode is associated with the computing device (and may also be associated with other operatively connected computing devices). During the online mode, the presently disclosed invention may be accessed by one or more users. The online mode comprises one, all, or some of the steps as described below. The online mode may begin with the computing device presenting to the user or multiple users the output of the predictive multi-output risk model trained during the off-line mode indicating the loan risk level associated with each of the plurality of loan accounts according to the periodic basis up to the adjusted look-ahead timeframe p.

During the online mode an option for semi-automatic loan analysis is presented to the user or multiple users via a first graphic user interface in the multi-window computer-based tool, allowing the user or multiple users to be presented the output of the predictive multi-output risk model indicating the loan risk level associated with each of the plurality of loan accounts via the multi-window computer-based tool within the predetermined maximum look-ahead timeframe p according to the periodic basis. An option for automatic loan analysis is also presented to the user or multiple users via a second graphic user interface in the multi-window computer-based tool allowing the user or multiple users to be automatically presented with one or a plurality of loan accounts at a greatest level of risk of all loan accounts within the predetermined maximum look-ahead timeframe p according to the periodic basis via display in the multi-window computer-based tool. Before presenting these options, the computing device may determine a number of users using the multi-window computer-based tool.

The first graphic user interface window may also present further options such as allowing the user or multiple users to select, drag, and rank loan accounts in the multi-window computer-based tool or present the option of selecting two or more loan accounts for comparison at two or more points in time.

The first graphic user interface window may allow the user or multiple users to adjust the predetermined look-ahead timeframe p and, upon adjustment, trains a new predictive multi-output risk model with the received plurality of loan account histories based on the adjusted maximum look-ahead timeframe p. If a user chooses to adjust the predetermined look-ahead timeframe p, the option for semi-automatic loan analysis presents the output of the new predictive multi-output risk model indicating the loan risk level associated with each of the plurality of loan accounts via the multi-window computer-based tool according to the periodic basis up to the adjusted look-ahead timeframe p.

Finally, the first graphic user interface window may inform the user or multiple users of the loan risk level associated with each of the plurality of loan accounts via one of the following: (a.) display of the loan risk level associated with each of the plurality of loan accounts at a beginning of the maximum adjusted look-ahead timeframe p according to the periodic basis; (b.) display of the loan risk level associated with each of the plurality of loan accounts at an end of the adjusted maximum look-ahead timeframe p according to the periodic basis, and (c.) display of a determination of whether the loan risk level associated with each of the plurality of loan accounts is anticipated to be at a level of risk higher than a level of risk threshold for each intervening period within the periodic basis up to the end of the adjusted maximum look-ahead timeframe p.

The second graphic user interface associated with the option for automatic loan analysis may also present further options. The second graphic user interface may only present loan accounts which are not actively monitored by the user or multiple users. The second graphic user interface window may further present the one or plurality of loan accounts at the greatest level of risk of all loan accounts by presenting the one or plurality of loan accounts at the greatest level of risk in batches of a given size. The batches may consist of 1, 2, 3, 4, 10, 20, 25, or 50 loan accounts, may be in the range of 1 through 50, or any other number. In such a case, the computing device may consider that each user processes a certain number of loan accounts simultaneously and the computing device may assign loan accounts to users according to a metric that indicates a length of time a loan account has been unattended by a user. The metric may be calculated by an equation such as:

$${T}_{{k}_{j}^{*}} ( {t}^{′} ) \geq \frac{1}{n - m + 1} {\sum }_{{k}_{j} ∈ {U}_{j}^{a} ( t )} {T}_{{k}_{j}} ( {t}^{′} ) , {k}_{j}^{*} ( {t}^{′} ) = {max}_{{k}_{j} ∈ {U}_{j}^{a} ( t )} \{ {τ}_{{k}_{j}} ( {t}^{′} ) \} or$$

$${T}_{{k}_{j}^{*}} ( {t}^{′} ) = {max}_{{k}_{j} ∈ {U}_{j}^{a} ( t )} \{ {T}_{{k}_{j}} ( {t}^{′} ) \} ,$$

or any other.

The computing device may assign loan accounts to users according to a half-daily basis, a daily basis, a weekly basis, a monthly basis, and a bi-monthly basis.

The computing device may assign loan accounts unattended for a length of time in any embodiment. The length of time a loan account must be unattended before being assigned may be any time period which has passed during which a user has not reviewed a loan account, such as one hour, one day, two days, one week, one month, or six months.

The second graphic user interface may prioritize display of the one or the plurality of loan accounts at the greatest level of risk of all loan accounts via a further criterion selected by the user or multiple users. The criterion may be (a.) a level of variance in a predicted level of risk of one or a plurality of loan accounts at the greatest level of risk from a baseline value during the maximum look-ahead timeframe p according to the periodic basis; (b.) monotonic increasing of the predicted level of risk of one or the plurality of loan accounts at the greatest level of risk during the maximum look-ahead timeframe p according to the periodic basis; and/or (c.) monotonic decreasing of the predicted level of risk of the one or plurality of loan accounts at the greatest level of risk during the maximum look-ahead timeframe p according to the periodic basis.

These and other aspects, objectives, features, and advantages of the disclosed technologies will become apparent from the following detailed description of illustrative embodiments thereof, which is to be read in connection with the accompanying drawings.

### BRIEF DESCRIPTION OF THE DRAWINGS

FIGS. 1A and 1B are flowcharts indicating the process of execution of a multi-window computer-based tool in an embodiment of the invention.

FIG. 2 is an image of a graphical-user interface in an embodiment of the invention.

FIG. 3 is a pie chart displaying the results obtained by users monitoring loan accounts in an embodiment of the invention.

FIG. 4 is an exemplary list of accounts presented to a user in an embodiment of the invention.

FIG. 5 is a flowchart displaying definition of variables in an embodiment of the invention.

FIG. 6 is a graph illustrating automatic loan analysis in an embodiment of the invention.

FIG. 7 is a flowchart displaying a process of automatic loan analysis and assignment in an embodiment of the invention.

### DETAILED DESCRIPTION

Describing now in further detail these exemplary embodiments with reference to the figures as described herein, the method, system, and apparatus for semi-automatic and automatic risk targeting and action prioritization in loan monitoring applications is described below. It should be noted that the drawings are not to scale.

A “loan account” (within the context of this and associated patent applications) and the associated “loan account history” describing the loan account is a record of debt for the lending of money (typically, for a specific purpose such as a payment for school tuition, refinancing a house, purchasing an automobile, etc.). A loan account contains one or more of the following: principal amount, interest rate, terms of repayment, date(s) of repayment, etc. As discussed within this patent application and associated patent applications, a loan account and an associated loan account history exist in a format accessible to a computing device for processing as a spreadsheet, .csv value, a matrix (as defined by certain programming languages), an array, a database entry, a linked-list, a free-structure, other types of computer files or variables (or any other presently existing or after-arising equivalent). Variables tracked include the origination date of the loan, the original amount of the loan, the remaining principle balance to be paid, the date of the monthly payment, the current interest rate, the terms of repayment, number of original monthly payments, number of remaining monthly payments, whether each monthly payment was timely (true/false), number days delinquent of every monthly payment (from 0 to a positive integer), credit score of loan account holder at various points in time, etc. In a further embodiment of the invention, variables further include loan status (is) (current or not), delinquency days (dd), and forbearance months (fm).

A “computing device,” as discussed in the context of this patent application and related patent applications, refers to one or multiple computer processors acting together, a logic device or devices, an embedded system or systems, or any other device or devices allowing for programming and decision making. Multiple computer systems may also be networked together in a local-area network or via the internet to perform the same function. In one embodiment, a computing device may be multiple processors or circuitry performing discrete tasks in communication with each other. The system, method, and apparatus described herein are implemented in various embodiments to execute on a “computing device[s],” or, as is commonly known in the art, such a device specially programmed in order to perform a task at hand. A computing device is a necessary element to process the large amount of data (i.e., thousands, tens of thousands, hundreds of thousands, or more of loan accounts and loan account histories). Furthermore, the present invention may take the form of a computer program product embodied in any tangible medium of expression having computer usable program code embodied in the medium. Computer program code for carrying out operations of the present invention may operate on any or all of the “server,” “computing device,” “computer device,” or “system” discussed herein. Computer program code for carrying out operations of the present invention may be written in any combination of one or more programming languages, including an object-oriented programming language such as Java, Smalltalk, C++, or the like, conventional procedural programming languages, such as Visual Basic, “C,” or similar programming languages. After arising programming languages are contemplated as well.

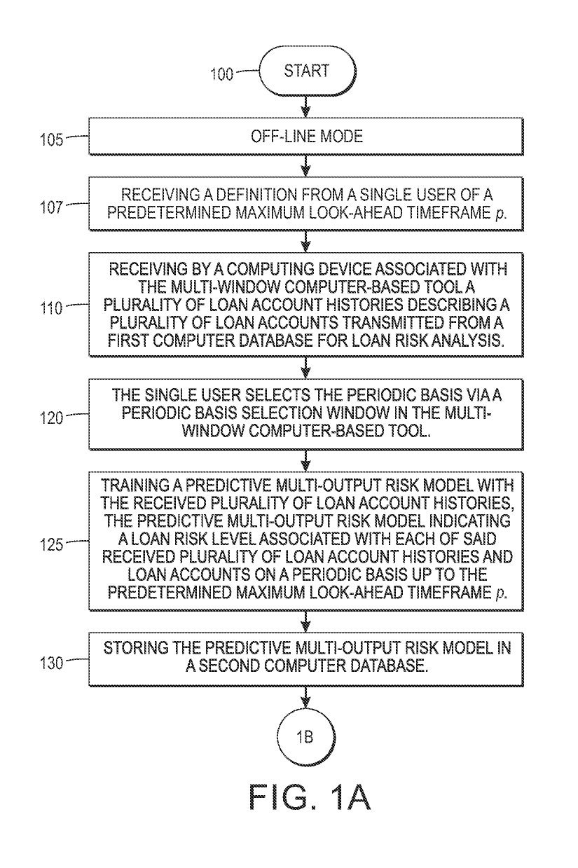

Referring to FIGS. 1A and 1B, displayed is a flowchart indicating a process of execution of a multi-window computer-based tool in an embodiment of the invention. In practice, the invention may comprise some, all, or none of these steps displayed in FIGS. 1A and 1B, or additional ones not displayed. The steps may even be performed concurrently or sequentially in embodiments of the invention. The order in which steps are performed may change as well. In FIG. 1A, execution begins at START 100. In an embodiment of the invention execution begins in an “Off-Line Mode” 105, where not all functionality of the invention will be available to all users, and the multi-window computer-based tool is simply in a set-up phase. Steps 107 through 130 may take place during “Off-Line Mode.”

A single user may initiate all set-up for the multi-window computer-based tool during the “Off-Line Mode” 105 associated with a computing device. “Users,” as discussed herein, refer to any person, persons, or entities who express an interest in setting up the multi-window computer-based tool or utilizing the multi-window computer-based tool seeking data regarding one or more loan accounts. Users may be but are not limited to customer service representatives, agents communicating on behalf of lenders, persons representing the loan issuer or servicer, or any other person, persons, or entities evaluating risk to a loan account or a plurality of loan accounts. A “user” may even be other computer software or computer “daemons” established to automatically access the presently disclosed invention.

Off-Line Mode does not refer to the lack of connectivity by the computing device to a network or the internet, but rather the unavailability of certain functionality to a user or users during this stage as during a “set-up” mode. At step 107, a definition is received from a single user of a predetermined maximum look-ahead timeframe p. In an embodiment of the invention, the predetermined maximum look-ahead timeframe p is the furthest length of time into the future for which loan prediction is performed, as provided by the multi-window computer-based tool. The user may be presented with a window in the multi-window computer-based tool to enter a value for p. Any value may be utilized for p, but a range of six months to several years is typical. An initial value for p may also be pre-established. In general, as the value of the maximum look-ahead timeframe p increases the accuracy of risk predictions decreases (for these further away points in time).

At step 110, a computing device associated with the multi-window computer-based tool receives a plurality of loan account histories describing a plurality of loan accounts transmitted from a first computer database for loan risk analysis. The loan account histories are transmitted for the purpose of determination of risk associated with them and the associated loan accounts at various points in time, and thereafter presenting such data to a user. Determination of risk associated with the loan accounts is associated with automated planning and control of actions to be taken with regard to the loan accounts in certain embodiments of the invention. In order to gain the advantage of using the presently disclosed invention over a simple by-hand analysis of such loan accounts and loan account histories, in the presently disclosed invention the number of loan accounts processed is substantial. The number of loan account histories in question most likely numbers at least in the tens of thousands or even millions. A computing device is a necessary element to process this number of loan account histories in a realistic fashion.

Optionally, at step 120, in an embodiment of the invention, the user selects a periodic basis via a periodic basis selection window in the multi-window computer based tool (such as via a slider-bar, radio button, or other menu option selectors). Typically the periodic basis is a daily, weekly, bi-weekly, monthly, bi-monthly, or annual basis, although any periodic basis may be utilized. The periodic basis is a timeframe upon which loan risk will be analyzed. The periodic basis is utilized by the multi-window computer-based tool in generation of a multi-output risk model. In an embodiment of the invention, the periodic basis selection window presents only options for the user to decide upon of several available periodic bases. The periodic basis is used in several ways, as further detailed below. In further embodiments of the invention the periodic basis is pre-established.

At step 125 a predictive multi-output risk model is trained with the received plurality of loan account histories, the predictive multi-output risk model indicating a loan risk level associated with each of said received plurality of loan account histories and loan accounts according to a periodic basis up to the predetermined maximum look-head timeframe p. The multi-output risk model uses the computing device to analyze the received plurality of loan account histories. In an embodiment of the invention, the multi-output risk model has one output per period as defined by the periodic basis, up to the maximum look-ahead timeframe p. Again, a computing device is a necessary element to handle the large amount of data being processed in a realistic timeframe. Furthermore, complex mathematical models as utilized in the presently disclosed method, system, and apparatus require a computing device to be calculated within a reasonable time.

In an embodiment of the invention, the predictive multi-output risk model is trained (as in step 125) as follows: Given the training input data (from the plurality of m-dimensional loan account histories for n different loan accounts) x [symbol] R^{n×m} and the output data (containing risk metrics for n different accounts across look-ahead times 1 through p) y [symbol] R^{n×p}, proceed to derive a mapping β ∈ R^{m×p}. Thus, in one embodiment, the predicted risk values may be obtained by computing ŷ=x*β, where ŷ∈ R^{n×p} Note that the x may contain linear and nonlinear terms along its second dimension, so either linear or nonlinear models may be constructed. Also, it is understood that the second dimension of x may also contain temporal data. In one embodiment, l-dimensional data for k months is available in the loan account histories, so m=l×k. In another embodiment, the l-dimensional data comprises linear terms and non-linear combinations of the linear terms (e.g., quadratic terms, first-order interactions, cubic terms, second-order interactions, and so on).

For example, consider application of an embodiment of the invention proposed here to real data collected from n=197,125 accounts that have m=332 variables. Ten-fold cross-validation is used to specify the training and test data and select without loss of generality of the partial least squares regression (PLS) linear method to predict the risk values. Other regression methods may also be applied. The input data sets from the plurality of loan account histories contain information from 12 months and outputs (risk factors) are computed for each of the p=6 months ahead from now. Thus, the model will estimate the risk from 1 month (M1) to 6 months (M6 below) ahead of defaulting. Table 1 (as below) shows the MSE for the training and testing.
MSE values obtained for the training and testing sets using PLS.

| | | | Train | Train | Train | Train |
|---|---|---|---|---|---|---|
| | Train M1 | Train M2 | M3 | M4 | M5 | M6 |
| Algorithm | (MSE) | (MSE) | (MSE) | (MSE) | (MSE) | (MSE) |
| PLS | 279.75 | 375.8 | 425.31 | 445.78 | 463.64 | 475.72 |
| | Test M1 | Test M2 | Test M3 | Test M4 | Test M5 | Test M6 |
| Algorithm | (MSE) | (MSE) | (MSE) | (MSE) | (MSE) | (MSE) |
| PLS | 284.42 | 371.02 | 418.67 | 441.24 | 460.34 | 474.32 |

*Note that the accuracy, as expected, is better for the months closer to the present.

Original input data: Contains a set of variables from the plurality of loan account histories x [symbol] R^{n×m} from current month (mc) up to i months back (mc−i), where i [symbol] Z (integer numbers). In this case, k=i+1.

Output data: Contains the risk factors y [symbol] R^{n×p} assigned to all loan accounts from one month ahead up top months ahead (mc+p) from the current month (i.e., from 1 through mc+p). Let y(k) [symbol] R^{p} denote the risk factors assigned to loan account k. In various embodiments the computation of risk values or risk intervals associated with each bank account is performed by inspection of the set y. Rules to assign risk values or risk intervals may be applied via standard logic, fuzzy logic, or even via an expert carrying out an inspection of the accounts themselves.

Performance metric: The performance is evaluated using the mean squared error between the actual and estimated risk values, available in the original input data. Other performance metrics can be used, including mean absolute error, mean absolute scaled error, etc.

Returning to FIG. 1A, at 130 the predictive multi-output risk model is stored in a second computer database. The second computer database may be a physical, stand-alone separate database separate from the first database, a logical partition of the same physical unit, or any other presently existing or after-arising equivalent allowing computer-accessible data storage. Storage is performed for future use of the data.

Execution continues onto FIG. 1B, in an embodiment of the invention, in an “On-Line Mode” 135. In the On-Line mode 135, a user (or multiple users) log onto the multi-window computer-based tool and interactively submit single/multiple real-time requests for data.

Steps 140 through 180 also take place during “On-Line Mode,” during which the multi-window computer-based tool is available to one user or multiple users to analyze risk associated with loan accounts and automatically make or assist in making loan planning decisions. As previously noted, in various embodiments of the invention, steps described 140 through 180 take place in any order, or individual steps may not take place at all. Additional steps not discussed may take place as well. In further embodiments of the invention, after completion of execution (as after steps 149 or 180), execution terminates or returns to steps 135 or 105 (of FIG. 1A).

In an embodiment of the invention, at step 140 the output of the predictive multi-output risk model previously trained is displayed to the logged-in user or users. The output of the predictive multi-output risk model indicates the loan risk level associated with each of the plurality of loan accounts according to the periodic basis up to the adjusted look-ahead timeframe p. This occurs during the online mode and previous to the user or multiple users being presented the option for semi-automatic loan analysis 145 or the option for automatic loan analysis 155. This display takes place in the embodiment of the invention via a computer monitor or printer associated with the computing device and that a user or users have access to.

At step 145, an option for a semi-automatic loan analysis is presented to the user or multiple users via a first graphic user interface window in the multi-window computer-based tool. This option allows the user or multiple users to be presented the output of the predictive multi-output risk model indicating the loan risk level associated with each of the plurality of loan accounts via the multi-window computer-based tool within the predetermined maximum look-ahead timeframe p according to the periodic basis. In an embodiment of the invention, the first graphic user interface window may also allow the user or multiple users to select, drag, and rank loan accounts in the multi-window computer-based tool. This is to facilitate a user or users viewing the loan accounts in an accessible fashion. The option to select, drag, and rank loan accounts in the multi-window computer-based tool allows the user or users to move and place loan accounts displayed in the first graphic user interface in more visible locations, allowing the user to best visualize, analyze, and manipulate the various loan accounts he or she is responsible for. Clicking and dragging, menus, and hot keys are convenient ways for a user or users to access this information.

At step 146 the first graphic user interface window additionally allows the user or multiple users to adjust the predetermined maximum look-ahead timeframe p, and, upon adjustment, trains a new predictive multi-output risk model with the received plurality of loan account histories based upon the adjusted maximum look-ahead timeframe p.

At step 147 the output of the new predictive multi-output risk model indicating the loan risk level associated with each of the plurality of loan accounts according to the periodic basis up to the adjusted look-ahead timeframe p is presented to the user or users. In an embodiment of the invention, the first graphic user interface further informs the user or multiple users of the loan risk level associated with each of the plurality of loan accounts via display of the following (a.)-(c.). (a.) A loan risk level associated with each of the plurality of loan accounts at the beginning of the adjusted maximum look-ahead timeframe p, according to the periodic basis; (b.) A loan risk level associated with each of the plurality of loan accounts at the end of the adjusted maximum look-ahead timeframe p according to the periodic basis; and (c.) A determination of whether the loan risk level associated with each of the plurality of loan accounts is anticipated to be at a level of risk higher than a level of risk threshold for each intervening period within the periodic basis up to the adjusted maximum look-ahead timeframe p.

At step 149, in an embodiment of the invention, the first graphic user interface window presents the option to the user or users selecting two or more loan accounts for comparison at two or more points in time.

As an alternate to selection of the option for semi-automatic loan analysis (as discussed above, with regard to steps 145 et seq.), at step 155, an option is presented for automatic loan analysis to users or multiple users via a second graphic interface window in the multi-window computer-based tool. The option for automatic loan analysis allows the user or multiple users to be automatically presented with one or a plurality of loan accounts at a greatest level of risk of all loan accounts within a maximum look-ahead timeframe p (which may be in various embodiments of the invention, either a predetermined maximum look-ahead timeframe or an adjusted maximum look-ahead timeframe p). If selected, the user(s) are then presented with the one or plurality of loan accounts at the greatest level of risk via display in the multi-window computer-based tool. In an embodiment of the invention the computing device assigns loan accounts to users according to a metric that indicates a length of time a loan account has been unattended by a user: the longer the length of time unattended relative to the length of time other loan accounts are unattended, the more likely a loan account is to be assigned. In a further embodiment of the invention, loan accounts are assigned to users on a half-daily, daily, weekly, monthly, or bi-monthly basis. In yet a further embodiment of the invention, loan accounts unattended for any length of time are assigned by the computing device.

In an embodiment of the invention, the first graphic user interface window (as discussed in step 145) and second graphic user interface window (as discussed in step 155) are actually contained in the same graphic user interface or window. As a user or users continue to access the multi-window computer-based tool in the course of performing his or her duties regarding loan analysis, her or she might switch back and forth between the first graphic user interface and second graphic user interface or use one graphic user interface to completion and then the next to completion.

In an embodiment of the invention, previous to presenting the option for automatic loan analysis as discussed in connection with step 155, at step 142 the computing device determines a number of users using the multi-window computer-based tool. In various embodiments of the invention, the determination of the number of users using the multi-window computer-based tool occurs previous to, during, or after the first or second graphic user interface is presented to the user or users.

At step 160 the second graphic user interface prioritizes display of the one or plurality of all loan accounts via a further criterion. The second graphic user interface may, for example, only present loan accounts which are not actively monitored by the user or multiple users. With multiple users accessing the multi-window computer-based tool, the number of users as well as which loan account or accounts each user is actively tracking, processing, or otherwise pursuing (such as by a user sending an email, calling, mailing a letter, or any other action directed towards a loan account by a user) is monitored, and the option for automatic loan analysis will thus only present loan accounts which are not being currently actively tracked by a user or multiple users of the multi-window computer-based tool. In further embodiments of the invention, the second graphic user interface prioritizes display of the one or plurality of loan accounts at the greatest level of risk of all loan accounts via another criterion such as: (a.) a level of variance in a predicted level of risk of one or the plurality of loan accounts at the greatest level of risk from a baseline variance value during the maximum look-ahead timeframe p according to the periodic basis; (b.) monotonic increasing in the predicted level of risk of the one or the plurality of loan accounts at the greatest level of risk during the maximum look-ahead timeframe p according to the periodic basis; and (c.) monotonic decreasing of the predicted level of risk of the one or the plurality of loan accounts at the greatest level of risk during the maximum look-ahead timeframe p according to the periodic basis. In a further embodiment of the invention, the display of the plurality of loan accounts at the greatest level of risk is updated when new data is available regarding the plurality of loan account histories. The second graphic user interface may only present the one or plurality of loan accounts in batches of a given size. In yet a further embodiment of the invention, the second graphic user interface only presents the one or plurality of loan accounts in batches of 1, 2, 3, 5, 10, 20, 25, or 50.

In a further embodiment of the invention, after step 160 at step 180 the computing device assigns loan accounts according to an assignment algorithm. In various embodiments of the invention, the assignment algorithm may be:

$${T}_{{k}_{j}^{*}} ( {t}^{′} ) \geq \frac{1}{n - m + 1} {\sum }_{{k}_{j} ∈ {U}_{j}^{a} ( t )} {T}_{{k}_{j}} ( {t}^{′} ) , {k}_{j}^{*} ( {t}^{′} ) = {max}_{{k}_{j} ∈ {U}_{j}^{a} ( t )} \{ {τ}_{{k}_{j}} ( {t}^{′} ) \} or$$

$${T}_{{k}_{j}^{*}} ( {t}^{′} ) = {max}_{{k}_{j} ∈ {U}_{j}^{a} ( t )} \{ {T}_{{k}_{j}} ( {t}^{′} ) \} ,$$

or any other.

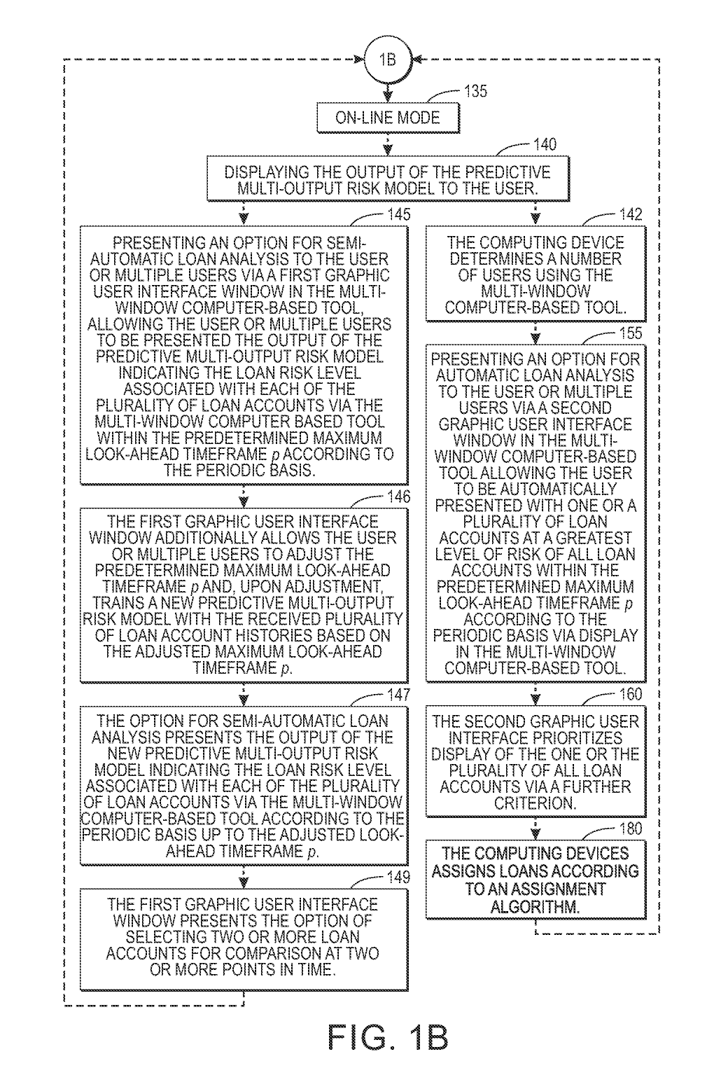

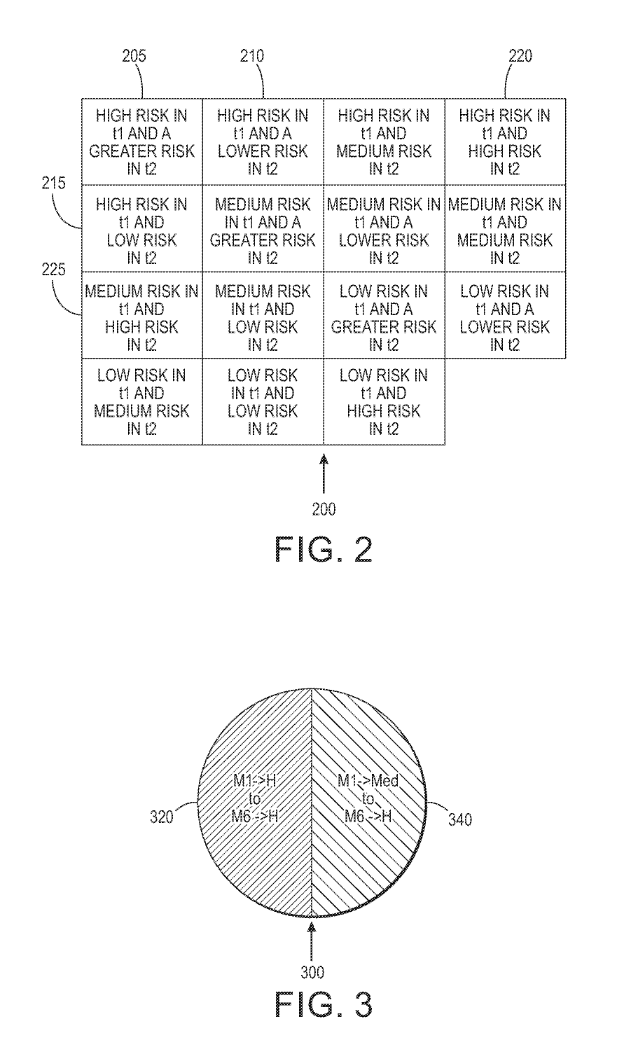

Referring to FIG. 2, displayed is a graphical user interface 200 presented to a user in an embodiment of the invention. The graphical user interface 200 allows the user to select two or more loan accounts or groups of loan accounts for comparison at two or more points in time. For the current example, a user may have previously selected t₁=one month from the current month, and t₂=six months from the current month. If a user clicks on 205, “High Risk in t₁, and a Greater Risk in t₂,” then all loan accounts with a high risk at time t₁ and with a higher risk at time t₂ will be displayed or printed. If the user selects 210, “High Risk in t₁, and a Lower Risk in t₂,” then all loan accounts with high risk at time t₁ and with a lower risk at time t₂ will be displayed or printed. Providing such details to a user allows the user to recognize trends on risk behavior of loan accounts since they indicate risks associated with loan accounts at time t₂>t₁, and indicate whether risk will increase or decrease relative to t₁. Other options presented include comparing loan accounts with a different status and not a relative status. For example, if the user clicks on 215, “High Risk in t₁ and Low Risk in t₂,” then all loan accounts with high risk at t₁ and low risk in t₂ will be displayed or printed. In an embodiment of the invention, high risk indicates risk>90; medium risk indicates 90≧risk>10; and low risk indicates risk≦10. These numbers are merely exemplary, and in an embodiment of the invention users define thresholds according to specific criterion or experience. Further categorization is possible as well, with risk levels such as low, low-medium, medium, medium-high, and high. The graphical user interface 200 also presents the option for a user to highlight multiple targets and combine the found loan accounts into one result in another window. For example, a user may highlight 220, “High Risk in t₁ and High Risk in t₂,” and 225, “Medium Risk in t₁ and High Risk in t₂” and the user will be presented with a pie-chart, as discussed below in connection with FIG. 3.

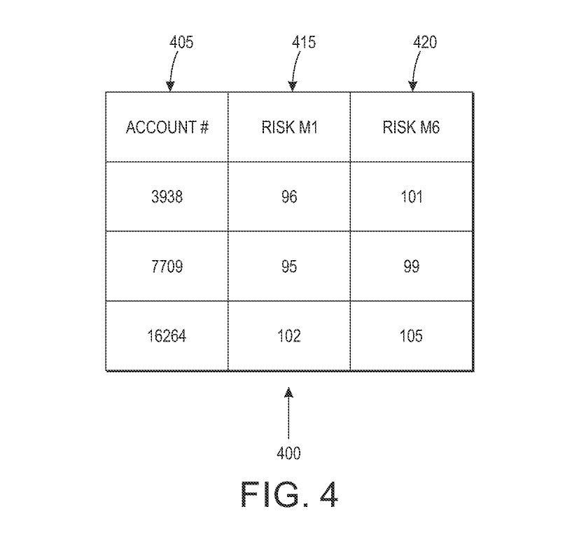

Referring to FIG. 3, displayed is a pie chart 300 displaying the results obtained by the user when clicking on FIG. 2, 220, “High Risk in t₁ and High Risk in t₂,” and 225, “Medium Risk in t₁ and High Risk in t₂” in an embodiment of the invention. Within FIG. 3, loan accounts in “High Risk in t₁ and High Risk in t₂,” are displayed in section 320. Loan accounts in “Medium Risk in t₁ and High Risk in t₂,” are displayed in section 340. The user presented with pie chart 300 is also capable of determining relative percentages of loan accounts at varying levels of risk by review of the relative size (or arc length) of sections 320 and 340. If the user clicks on segment 320, “High Risk in t₁ and High Risk in t₂,” the user will be presented with a list of loan accounts at that level of risk (as discussed further in connection with FIG. 4). By having access to this data as displayed in FIG. 3, the user can focus on establishing priorities for high risk loan accounts. For example, a user may prioritize review on loan accounts at high risk one month in the future versus review of loan accounts at high risk six months in the future. In this way, users may take immediate action on accounts predicted to default first in the near future.

Referring to FIG. 4, displayed is an exemplary list of accounts 400 presented to a user if he or she clicks on FIG. 3, (for example) segment 320 “High Risk in t₁ and High Risk in t₂” in an embodiment of the invention. The account number of the loan accounts displayed in the exemplary list of accounts 400 is presented in column 405. The estimated risk at one month from the current month (“Risk M1”) is displayed in column 415. The estimated risk at six months from the current month (“Risk M6”) is displayed in column 420. A user or users is thusly able to focus on loan accounts at risk in the immediate future versus those at risk in the more distant future.

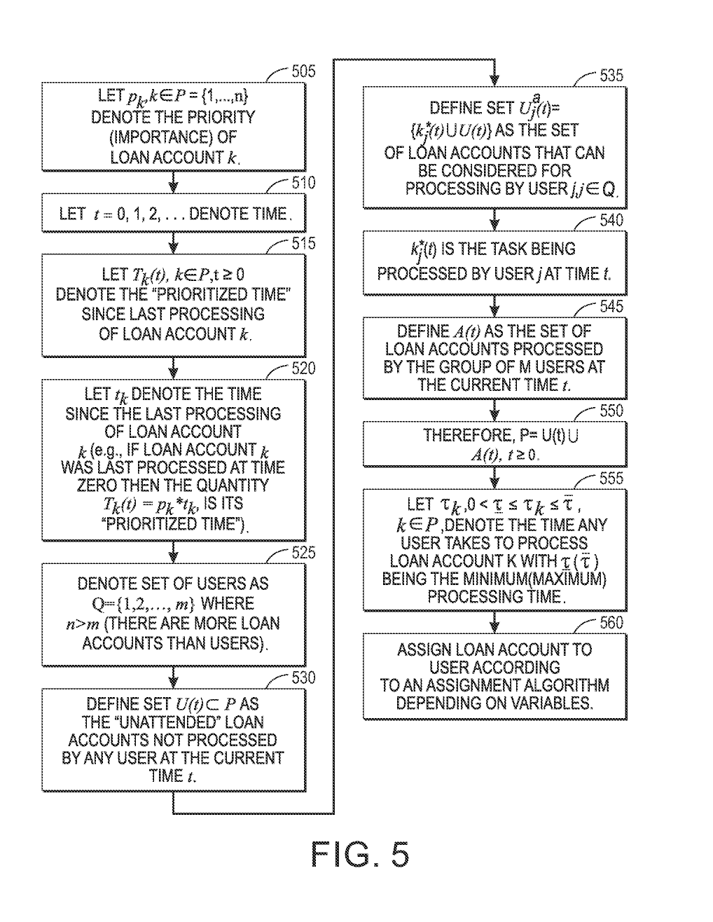

Referring to FIG. 5, displayed is a flowchart displaying the definition of variables for automatic loan analysis in an embodiment of the invention. At 505, let pₖ, k ∈ P={1, . . . , n} denote the priority (importance) of loan account k. At 510, let t=0, 1, 2, . . . denote time. At 515, let Tₖ(t), k ∈ P, t≧0 denote the “prioritized time” since last processing of loan account k. At 520, let tₖ denote the time since the last processing of loan account k (e.g., if loan account k was last processed at time zero then the quantity Tₖ(t)=pₖ*tₖ, is its “prioritized time”). At 525 denote a set of users of the multi-window computer-based tool as Q=[1,2, . . . , m} where n>m (there are more loan accounts than users). At 530 define the set U(t)⊂ P as “unattended” loan accounts not processed or being pursued by any user at the current time t. At 535 define set Uⱼ^{a}(t)={k*ⱼ(t)∪ U(t)} as the set of loan accounts that may be considered for processing by user j, j ∈ Q. At 540, k*ⱼ(t) is the task being processed by user j at time t. At 545 define A(t) as the set of loan accounts processed by the group of m users at the current time t. At 550, therefore, P=U(t)∪ A(t), t≧0. At 555, let τₖ, 0<τ≦τₖ≦ τ̅, k ∈ P, denote the time any user takes to process loan account k with τ( τ̅) being the minimum (maximum) processing time. Here processing could include actions such as sending an email, calling, mailing a letter to the account holder, or any other action aimed at addressing a risky loan account. If the actions have no effect, priority for the account remains the same. If the actions are effective, pₖ for the account will change, and the account is not frequently allocated to a user. At 560, loan accounts are assigned to a user according to the determined variable depending on an assignment algorithm.

Examples are provided as follows: In an embodiment of the invention, at time t′, each user j ∈ Q is given an account k*ⱼ ∈ P such that

$${T}_{{k}_{j}^{*}} ( {t}^{′} ) \geq \frac{1}{n - m + 1} {\sum }_{{k}_{j} ∈ {U}_{j}^{a} ( t )} {T}_{{k}_{j}} ( {t}^{′} ) .$$

If Tₖ_{ⱼ} is equal for several accounts, ties are broken between accounts with equal Tₖ_{ⱼ} arbitrarily such as by a random number. Other strategies may be implemented. In another embodiment of the invention, the assignment algorithm Tₖ_{ⱼ}*(t′)=maxₖ_{^{∈U}}ⱼ_{^{a}}₍ₜ₎{Tₖ_{ⱼ}(t′)} is used to assign loan accounts to a user for review. Once the loan account k*ⱼ has been selected at time t′, then Tₖ_{ⱼ}*(t′+1)=0 indicates that loan account k*ⱼ is no longer being ignored by the users. Since the computing device or assignment algorithm implemented by the computing device will request the set U(t) m times at the same time, a mutual exclusion algorithm is used to coordinate access to the set U(t) in such a way that this set may be accessed and updated only once at a time. In another embodiment, a simpler option is to pre-establish the order in which the decisions will be made at all times. This may occur, in an embodiment of the invention, by a first user selecting a first account, a second user a second account, etc., although any order is contemplated. The strategies mentioned above allocate only one loan account k*ⱼ to user j, but in another embodiment of the invention a set of loan accounts are allocated to a user simultaneously.

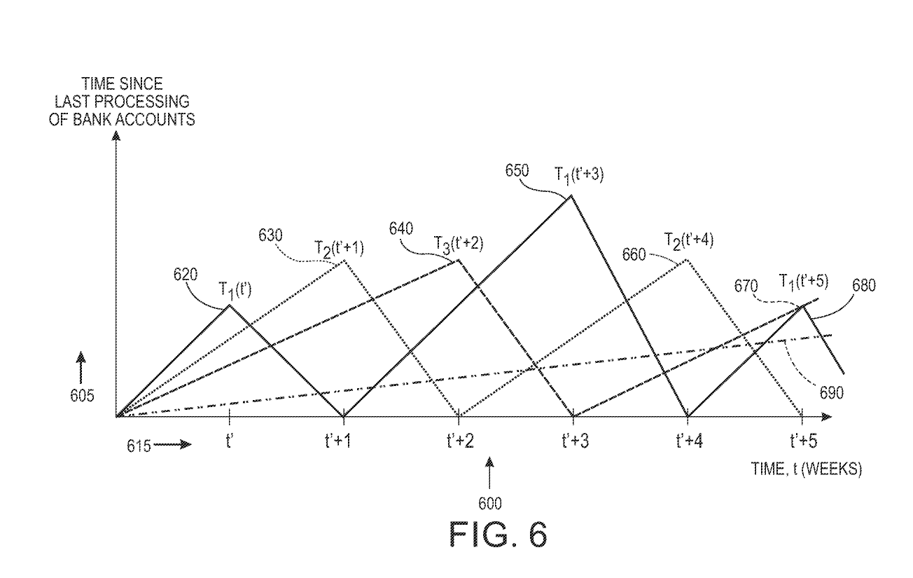

Referring to FIG. 6, displayed is a graph 600 illustrating automatic loan analysis as performed by an embodiment of the invention. X-axis 615 describes time that has passed since the last processing of an individual loan account by a user. Y-axis 605 describes the prioritized time (in weeks, in this embodiment). Four loan accounts are considered in graph 600 (n=4). Loan account 1 (620, 650, 680), loan account 2 (630, 660), loan account 3 (640, 670), and loan account 4 (690). At time t′, the value of prioritized time since the last processing of loan account 1 is T₁(t′)>0, as shown in FIG. 6. The user then decides to process loan account 1 (620) (or, in an embodiment of the invention, the computing device or an assignment algorithm allocates loan account 1 to a user). At time t′ (620) the user initiates the processing of loan account 1, and the amount of time it takes to do so is dictated by the τ₁=1 (t′+1−t′) parameter. When processing for loan account 1 is completed at time t′+1, the user chooses to process loan account 2 (630) (or, again, in an embodiment of the invention the user is allocated loan account 2 via a computing device or an assignment algorithm). This processing is repeated so that, in this case, the user processes accounts in the following order: (loan account 1, loan account 2, loan account 3, loan account 1, loan account 2, loan account 1, . . . }. Note that loan account 4 (690) has a low priority, and is not chosen during this time frame but instead as its associated prioritized time rises above the prioritized time of other loan accounts in question, it will be processed by a user. Note also that the processing time τ₁ does not depend on the value of T₁(t′), T₁(t′+3) or T₁(t′+5), since no matter what the current value of the prioritized time since last processing of a loan account is, the user will always take τ₁ time units to process loan account 1. One consequence of this is that the slope of T₁ will not be the same each time a user is processing a loan account.

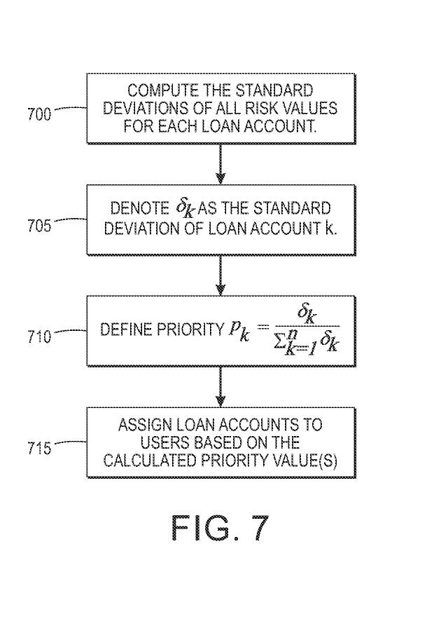

Referring to FIG. 7, displayed is a flowchart showing a process of automatic loan analysis and assignment to a user (or multiple users) based upon review of loan accounts with a high level of variance in risk, in an embodiment of the invention. Assume one loan account is assigned to one user (although in other embodiments multiple loan accounts may be assigned to a single user) and that all loan accounts are assigned for review to a user on a monthly basis, or according to any other periodic basis.

At 700, compute the standard deviation of risk values for each loan account. This calculation takes place via methodology as commonly known to one of skill in the art, and considering the number of loan accounts at issue (at least tens of thousands), a computing device is necessary for these calculations.

At 705, denote variable δₖ as the standard deviation of loan account k. At 710, denote priority

$${p}_{k} = \frac{{δ}_{k}}{{\sum }_{k = 1}^{n} {δ}_{k}} .$$

In an embodiment of the invention assume that priority is constant all the time, but in other embodiments it may be updated. At 715, the calculated priority value is used to assign loan accounts to users. Loan accounts may be assigned to users on a monthly basis or otherwise.

In other embodiments of the invention other values are used to assign loan accounts to users. eₖ is calculated for loan account k (with eₖ=[y(k)[i+2]−y(k)[i+1] . . . y(k)[i+p]−y(k)[i+p−1]], where y(k)[i+2] denotes the risk factor of loan account k two months from the current month. Now δₖ for account k may be computed as the standard deviation of the vector eₖ. If users are only interested in loan accounts with monotonically increasing risk values, loan accounts may be selected that have elements eₖ with values greater than or equal to zero. If users are interested in loan accounts with monotonically decreasing risk values, loan accounts may be selected that have values less than or equal to zero.

The preceding description has been presented only to illustrate and describe the invention. It is not intended to be exhaustive or to limit the invention to any precise form disclosed. Many modifications and variations are possible in light of the above teachings.

The preferred embodiments were chosen and described in order to best explain the principles of the invention and its practical application. The preceding description is intended to enable others skilled in the art to best utilize the invention in its various embodiments and with various modifications as are suited to the particular use contemplated. It is intended that the scope of the invention be defined by the following claims.

What is claimed is:

1. A method for loan risk targeting and action prioritization using a multi-window computer-based tool associated with a computing device having an off-line mode and an online mode offering semi-automatic and automatic loan analysis capabilities for a user or multiple users comprising:
In the off-line mode associated with the computing device:
Receiving a definition from a single user of a predetermined maximum look-ahead timeframe p;
Receiving by the computing device associated with the multi-window computer-based tool a plurality of loan account histories describing a plurality of loan accounts transmitted from a first computer database for loan risk analysis;
Training a predictive multi-output risk model with the received plurality of loan account histories,
said predictive multi-output risk model indicating a loan risk level associated with each of said received plurality of loan account histories and loan accounts on a periodic basis up to the predetermined maximum look-ahead timeframe p;
Storing the predictive multi-output risk model in a second computer database;
In the online mode associated with the computing device:
Presenting an option for semi-automatic loan analysis to the user or multiple users via a first graphic user interface window in the multi-window computer-based tool, allowing the user or multiple users to be presented the output of the predictive multi-output risk model indicating the loan risk level associated with each of the plurality of loan accounts via the multi-window computer-based tool within the predetermined maximum look-ahead timeframe p according to the periodic basis; and
Presenting an option for automatic loan analysis to the user or multiple users via a second graphic user interface window in the multi-window computer-based tool allowing the user or multiple users to be automatically presented with one or a plurality of loan accounts at a greatest level of risk of all loan accounts within the predetermined maximum look-ahead timeframe p according to the periodic basis via display in the multi-window computer-based tool.

2. The method of claim 1 wherein the first graphic user interface window additionally allows the user or multiple users to adjust the predetermined maximum look-ahead timeframe p and, upon adjustment, trains a new predictive multi-output risk model with said received plurality of loan account histories based on the adjusted maximum look-ahead timeframe p.

3. The method of claim 1 wherein said first graphic user interface window further allows the user or multiple users to select, drag, and rank loan accounts in the multi-window computer-based tool.

4. The method of claim 1 wherein said periodic basis is selectively one of a daily, weekly, bi-weekly, monthly, bi-monthly, and annual basis.

5. The method of claim 1 wherein the single user selects the periodic basis during the off-line mode.

6. The method of claim 5 wherein the single user selects the periodic basis via a periodic basis selection window in the multi-window computer-based tool.

7. The method of claim 2 wherein the option for semi-automatic loan analysis presents the output of the new predictive multi-output risk model indicating the loan risk level associated with each of the plurality of loan accounts via the multi-window computer-based tool according to the periodic basis up to the adjusted look-ahead timeframe p.

8. The method of claim 1 wherein the first graphic user interface window further presents the option of selecting two or more loan accounts for comparison at two or more points in time.

9. The method of claim 1 wherein the second graphic user interface window only presents loan accounts which are not actively monitored by the user or multiple users.

10. The method of claim 1 wherein the second graphic user interface window prioritizes display of the one or the plurality of loan accounts at the greatest level of risk of all loan accounts via a further criterion selected by the user or multiple users, wherein the further criterion is selectively one of the following a.-c.:
a. A level of variance in a predicted level of risk of one or the plurality of loan accounts at the greatest level of risk from a baseline variance value during the maximum look-ahead timeframe p according to the periodic basis;
b. Monotonic increasing of the predicted level of risk of the one or the plurality of loan accounts at the greatest level of risk during the maximum look-ahead timeframe p according to the periodic basis; and
c. Monotonic decreasing of the predicted level of risk of the one or the plurality of loan accounts at the greatest level of risk during the maximum look-ahead timeframe p according to the periodic basis.

11. The method of claim 1 wherein the second graphic user interface window presents the one or plurality of loan accounts at the greatest level of risk of all loan accounts by presenting the one or plurality of loan accounts at the greatest level of risk in batches of a given size.

12. The method of claim 11 wherein said batches are in given sizes in the range of 1 through 50.

13. The method of claim 2 wherein the computing device during the online mode and previous to the user or multiple users being presented the option for semi-automatic loan analysis or the option for automatic loan analysis, displays to the user or multiple users output of the predictive multi-output risk model trained during the off-line mode indicating the loan risk level associated with each of the plurality of loan accounts according to the periodic basis up to the adjusted look-ahead timeframe p.

14. The method of claim 2 wherein the first graphic user interface window further informs the user or multiple users of the loan risk level associated with each of the plurality of loan accounts via selectively one of the following a.-c.:
a. Display of the loan risk level associated with each of the plurality of loan accounts at a beginning of the adjusted maximum look-ahead timeframe p according to the periodic basis;
b. Display of the loan risk level associated with the each of the plurality of loan accounts at an end of the adjusted maximum look-ahead timeframe p according to the periodic basis, and;
c. Display of a determination of whether the loan risk level associated with each of the plurality of loan accounts is anticipated to be at a level of risk higher than a level of risk threshold for each intervening period within the periodic basis up to the end of the adjusted maximum look-ahead timeframe p.

15. The method of claim 1 wherein during the online mode said computing device determines a number of users using the multi-window computer-based tool.

16. The method of claim 12 wherein said computing device considers that each user processes a number of loan accounts simultaneously.

17. The method of claim 16 wherein said computing device assigns loan accounts to users according to a metric that indicates a length of time a loan account has been unattended by a user.

18. The method of claim 17 wherein said metric is calculated by selectively one of following:
$${T}_{{k}_{j}^{*}} ( {t}^{′} ) \geq \frac{1}{n - m + 1} {\sum }_{{k}_{j} ∈ {U}_{j}^{a} ( t )} {T}_{{k}_{j}} ( {t}^{′} ) , {k}_{j}^{*} ( {t}^{′} ) = {max}_{{k}_{j} ∈ {U}_{j}^{a} ( t )} \{ {τ}_{{k}_{j}} ( {t}^{′} ) \} and$$
$${T}_{{k}_{j}^{*}} ( {t}^{′} ) = {max}_{{k}_{j} ∈ {U}_{j}^{a} ( t )} \{ {T}_{{k}_{j}} ( {t}^{′} ) \} .$$

19. The method of claim 12 wherein said computing device assigns loan accounts to users according to selectively one of following bases: half-daily, daily, weekly, monthly, and bi-monthly.

20. The method of claim 12 wherein loan accounts unattended for a length of time are assigned by the computing device.

21. The method of claim 15 wherein loan accounts unattended for a length of time are assigned by the computing device.

22. A method for loan risk targeting and action prioritization using a multi-window computer-based tool associated with a computing device having semi-automatic and automatic loan analysis capabilities for a user or multiple users comprising:
In an online mode associated with the computing device:
Presenting an option for semi-automatic loan analysis to the user or multiple users via a first graphic user interface window in the multi-window computer-based tool allowing the user or multiple users to be presented the output of the predictive multi-output risk model indicating risk associated with the plurality of loan accounts via the multi-window computer-based tool within the predetermined look-ahead timeframe p according to the period basis; and
Presenting an option for automatic loan analysis to the user or multiple users via a second graphic user interface window in the multi-window computer-based tool allowing the user or multiple users to be automatically presented with one or a plurality of loan accounts at a greatest level of risk of all loan accounts within the predetermined maximum look-ahead timeframe p according to the periodic basis via display in the multi-window computer-based tool.

23. The method of claim 22 wherein an off-line mode associated with the computing device and the multi-window computer-based tool precedes the online mode and the computing device performs the further steps during the online mode of:
Receiving a definition from a single user of a predetermined maximum look-ahead timeframe p;
Receiving by the computing device associated with the multi-window computer-based tool a plurality of loan account histories describing a plurality of loan accounts transmitted from a first computer database for loan risk analysis;
Training a predictive multi-output risk model with the received plurality of loan account histories,
said predictive multi-output risk model indicating a loan risk level associated with each of said received plurality of loan account histories and loan accounts on a periodic basis up to the predetermined maximum look-ahead timeframe p; and
Storing the predictive multi-output risk model in a second computer database.
